(19) United States
(12) Patent Application Publication
(10) Pub. No.: US 2008/0120093 A1
(43) Pub. Date: May 22, 2008

(54) SYSTEM FOR CREATING DICTIONARY FOR SPEECH SYNTHESIS, SEMICONDUCTOR INTEGRATED CIRCUIT DEVICE, AND METHOD FOR MANUFACTURING SEMICONDUCTOR INTEGRATED CIRCUIT DEVICE

(75) Inventors: Masamichi IZUMIDA, Ryugasaki (JP); Takao KATAYAMA, Matsumoto (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/940,364

(22) Filed: Nov. 15, 2007

(30) Foreign Application Priority Data
Nov. 16, 2006 (JP) 2006-310315
Aug. 29, 2007 (JP) 2007-222469

(51) Int. Cl. G06F 17/27

(52) U.S. Cl. 704/10

(57) ABSTRACT

A system for creating a dictionary for speech synthesis is provided. The system has a first dictionary for speech synthesis composed of an aggregation of dictionary data necessary for creating synthesized speech corresponding to an utterance target sentence, and creates, from the first dictionary for speech synthesis, a second dictionary for speech synthesis with a fewer data amount compared to the first dictionary for speech synthesis. The system includes: a first speech synthesis dictionary memory device that stores the dictionary data composing the first dictionary for speech synthesis; a second speech synthesis dictionary creating device that analyzes an utterance target sentence, checks frequency of occurrence of each word composing the utterance target sentence, decides words to be stored in the second dictionary for speech synthesis based on the frequency of occurrence, and creates the second dictionary for speech synthesis using the dictionary data stored in the first dictionary for speech synthesis corresponding to the decided words to be stored; and a speech synthesis device that creates synthesized speech corresponding to the utterance target sentence, using the second dictionary for speech synthesis.

The entire disclosure of Japanese Patent Application Nos: 2006-310315, filed Nov. 16, 2006 and 2007-222469, filed Aug. 29, 2007 are expressly incorporated by reference herein.

### BACKGROUND

1. Technical Field

The invention relates to systems for creating dictionary for speech synthesis, semiconductor integrated circuit devices, and methods for manufacturing the semiconductor integrated circuit devices.

2. Related Art

As TTS system speech synthesis LSIs that synthesize speech from text data that is an aggregation of character data, there are many different systems including a parametric system that synthesizes speech through modeling the human vocalizing process, a concatenative system that uses phoneme segments data composed of data of real human voices, and synthesizes speech through combining them according to the necessity and partially modifying the portion of concatenation thereof, and a corpus-based system, as a developed form of the aforementioned systems, that synthesizes speech from actual voice data through performing speech assembly based on linguistic-based analysis.

In any of the aforementioned systems, before converting sentence to speech, it is indispensable to have a conversion dictionary (data base) for converting notational text expression described by SHIFT-JIS codes or the like to “reading” of how the text expression should be pronounced.

Also, the concatenative system and the corpus-based system further require a dictionary (data base) for searching “phonemes” from the “reading.” Japanese Laid-open Patent Application JP-A-2003-208191 may be an example of related art.

In a single chip TTS-LSI that has a limited on-chip resource (such as a ROM capacity), when a mountable dictionary file for speech synthesis is limited to a relatively small amount of vocabulary, satisfactory speech quality may not be obtained as vocabulary to be accommodated is limited.

A system with a small storage capacity cannot have a “notation-to-reading” data dictionary or a “phoneme” dictionary that lists many effective cases to improve the speech quality. Therefore, if a sentence subject to reading includes a vocabulary portion that is not covered by the dictionary, the speech quality at that portion may deteriorate, or cannot be read.

### SUMMARY

In accordance with an aspect of an embodiment of the present invention, there is provided a sub-set speech dictionary that makes it possible to synthesize speech with good speech quality with respect to predetermined sentence subject to utterance (hereafter referred to as an “utterance target sentence”), with a necessary and sufficient amount of data.

(1) A system for creating a dictionary for speech synthesis has a first dictionary for speech synthesis composed of an aggregation of dictionary data necessary for synthesizing speech corresponding to an utterance target sentence, and creates, from the first dictionary for speech synthesis, a second dictionary for speech synthesis with a fewer data amount compared to the first dictionary for speech synthesis, wherein the system includes:

a first speech synthesis dictionary memory device that stores the dictionary data composing the first dictionary for speech synthesis;

a second speech synthesis dictionary creating device that analyzes an utterance target sentence, checks frequency of occurrence of each word composing the utterance target sentence, decides words to be stored in the second dictionary for speech synthesis based on the frequency of occurrence, and creates the second dictionary for speech synthesis using the dictionary data stored in the first dictionary for speech synthesis corresponding to the decided words to be stored; and

a speech synthesis device that creates synthesized speech corresponding to the utterance target sentence, using the second dictionary for speech synthesis.

The first dictionary for speech synthesis may be a full-set dictionary (a large capacity dictionary) having a dictionary data size that is capable of creating synthesized speech corresponding to arbitrary utterance target sentences, and the second dictionary for speech synthesis may be a subset dictionary (a small capacity dictionary) having a dictionary data size that is capable of creating synthesized speech corresponding to a specific utterance target sentence.

The first dictionary for speech synthesis may be comprised of, for example, a vocabulary dictionary (a “notation-to-reading” data dictionary), a phoneme dictionary (a dictionary that lists many effective cases to achieve higher speech quality) and the like. These dictionary data are stored in the first speech synthesis creating dictionary memory device, and function as a dictionary data base. It is noted that the kind of dictionary may be decided according to a system for speech synthesis, and may include, for example, both of a vocabulary dictionary and a phoneme dictionary, or only a vocabulary dictionary.

The vocabulary dictionary is a dictionary for performing a front-end processing in the text read-out processing, and is a dictionary that stores symbolic linguistic representations corresponding to text notations (for example, read-out data corresponding to text notations).

In the front-end processing, a processing to convert symbols like numbers and abbreviations contained in text into the equivalent of read-out words (which is called text normalization, pre-processing, or tokenization), and a processing to convert each word into phonetic transcriptions to thereby divide text into prosodic units, such as, phrases, clauses and sentences (the process to assign phonetic transcriptions to each word is called text-to-phoneme (TTP) conversion or grapheme-to-phoneme (GTP) conversion) are conducted. Phonetic transcriptions and prosodic information are combined together to make up the symbolic linguistic representation that is outputted.

In the text normalization processing, a processing to convert heteronyms, numbers, and abbreviations included in text into a phonetic representation that can be pronounced is conducted. In most text-to-speech (TTS) systems, meanings of their inputted texts are not analyzed, but various heuristic techniques are used to guess the proper way to disambiguate heteronyms, like examining neighboring words and using statistics about frequency of occurrence.

The phoneme dictionary is a dictionary that stores waveform information of actual sounds (phoneme) corresponding to inputted symbolic linguistic representation that is output of the front-end. The primary technologies for generating speech waveforms by the back-end are concatenative synthesis and formant synthesis. Concatenative synthesis is basically a method of synthesizing speech by stringing together segments of recorded speech.

The speech synthesis device synthesizes speech corresponding to the received utterance target sentence through performing front-end processing and back-end processing based on vocabulary information and phoneme information stored in the first dictionary for speech synthesis.

The second speech synthesis dictionary creating device may decide words to be stored, for example, through giving priority to words with higher frequency of occurrence. For example, of the storage capacity allocated in advance to the second dictionary for speech synthesis, a specific ratio (for example, 80%) may be allocated to words according to priority of higher frequency of occurrence. In this instance, if the frequency of occurrence does not reach a specified number (for example, twice), the storage allocation may be stopped even when the aforementioned ratio is not reached. The frequency of appearance generally forms a “long tail” type distribution, and therefore it can be expected that many parts of a target sentence can be covered by the arrangement described above.

The speech synthesis device uses the second dictionary for speech synthesis, thereby creating synthesized speech corresponding to an utterance target sentence, such that the user can confirm the result of speech synthesis of the utterance target sentence.

In accordance with the invention, a specified utterance target sentence is analyzed, and dictionary data necessary and sufficient for speech synthesis of the specified utterance target sentence is extracted from the first dictionary for speech synthesis, whereby the second dictionary for speech synthesis with a fewer amount of data compared to the first dictionary for speech synthesis can be created.

Accordingly, even when a speech dictionary file mountable on a single-chip TTS-LSI that has a limited on-chip resource (e.g., the ROM capacity) is limited to a relatively small amount of vocabulary, it is possible to create a subset dictionary (i.e., the second dictionary for speech synthesis) that enables speech synthesis with good accuracy for specific utterance target sentences.

According to the invention, by selectively extracting vocabulary to be stored in the second dictionary for speech synthesis, the data amount of the vocabulary dictionary can be reduced. By reducing the data amount of the vocabulary dictionary, the data amount of the corresponding phoneme dictionary is consequently reduced, such that the data amount of both of the vocabulary dictionary and the phoneme dictionary in the second dictionary for speech synthesis can be reduced.

(2) The system for creating a dictionary for speech synthesis in accordance with an aspect of the invention may include an utterance target sentence changing device that performs a change of an utterance target sentence in which unstored words that are not subject to storing in the second dictionary for speech synthesis among words composing an utterance target sentence are changed with the stored words in the second dictionary for speech synthesis.

The replacement may apply, for example, to the case where unstored words are replaced with their synonyms (synonyms that are stored in the second dictionary for speech synthesis), or to the case where unstored words are replaced with their kana notations (a dictionary for kana notations is assumed to be stored in the second dictionary for speech synthesis).

According to the invention, the accuracy of speech synthesis can be improved without increasing words stored in the second dictionary for speech synthesis.

The speech synthesis device uses the second dictionary for speech synthesis to thereby create synthesized speech corresponding to the utterance target sentence with modified words, such that the user can confirm the result of speech synthesis of the utterance target sentence after the modification.

(3) In the system for creating a dictionary for speech synthesis in accordance with an aspect of the invention, the utterance target sentence changing device may create a dictionary for speech synthesis characterizing in recording a change history concerning replacement of words composing the utterance target sentence.

The change history may include information for changed words and original words in the utterance target sentence corresponding to the changed words. Therefore, when a certain word is changed multiple times, the change history includes information for at least its original word (the word included in the initially given utterance target sentence) and the word finally changed.

The change history may be created independently of the utterance target sentence, or may be created in a form in which a comment on the change history is inserted in the utterance target sentence.

(4) In the system for creating a dictionary for speech synthesis in accordance with an aspect of the invention, the utterance target sentence changing device may include a synonym replacement processing device that performs a synonym replacement processing in which the unstored words are analyzed to check whether their synonyms are present in the stored words in the second dictionary for speech synthesis, and when there are synonyms, the unstored words of the utterance target sentence are replaced with the synonyms.

For example, when a first word and a second word included in the utterance target sentence are synonyms and interchangeable with each other, the first word is the stored word in the second dictionary for speech synthesis, and the second word is not the stored word in the second dictionary for speech synthesis, the processing to change utterance target sentence in accordance with the invention can be performed such that the second word in the utterance target sentence is replaced with the first word.

For example, a synonym dictionary that defines synonyms may be used to search synonyms of unstored words. For example, a synonym for each unstored word in an utterance target sentence may be searched in the synonym dictionary, and the second dictionary for speech synthesis may be searched to check whether the synonym obtained as a result of the search is a stored word in the second dictionary for speech synthesis. When the synonym is a stored word, a replacement processing may be performed such that the unstored word in the utterance target sentence is replaced with the stored word.

According to the invention, the accuracy of speech synthesis of sentences to be uttered can be improved without changing the meaning of the sentences to be uttered and without increasing the stored words of the second dictionary for speech synthesis.

It is noted that the speech synthesis device creates synthesized speech corresponding to an utterance target sentence after its words have been replaced with synonyms using the second dictionary for speech synthesis, such that the user can confirm the result of speech synthesis of the utterance target sentence after the replacement with the synonyms.

(5) In the system for creating a dictionary for speech synthesis in accordance with an aspect of the invention, the utterance target sentence changing device may include a kana replacement processing device that performs a kana replacement processing in which the unstored word is replaced with its equivalent kana notation that represents how the word is read.

Here, the second dictionary for speech synthesis may include dictionary data for performing speech synthesis corresponding to kana notation.

According to the invention, special words with low frequency of occurrence may be replaced with their corresponding kana notation (although naturalness in the intonation and accent may be somewhat deteriorated), such that the second dictionary for speech synthesis that enables speech synthesis of special sentences for utterance can be created.

(6) The system for creating a dictionary for speech synthesis in accordance with an aspect of the invention may include an edit processing device that receives an evaluation input with respect to an utterance target sentence that is speech-synthesized by using the second dictionary for speech synthesis, and renders a specifying or changing processing on the second dictionary for speech synthesis or the utterance target sentence according to the content of the evaluation input.

The evaluation input may be returned by, for example, OK or NG.

By so doing, the user can judge the synthesized speech of the utterance target sentence that is created by using the second dictionary for speech synthesis being created while actually listening to the synthesized speech, and can perform a processing to specify or change the second dictionary for speech synthesis or the utterance target sentence. Accordingly, the user can perform a processing to edit the second dictionary for speech synthesis while confirming the result in real time, whereby a user-friendly system for creating a dictionary for speech synthesis can be provided.

(7) In the system for creating a dictionary for speech synthesis in accordance with an aspect of the invention, the edit processing device may receive a user-designated input about a stored word of the second dictionary for speech synthesis, and the second speech synthesis dictionary creating device may decide the stored word based on the user-designated input.

For example, after deciding stored words for the respective corresponding words composing the utterance target sentence according to their frequency of appearance, words that may be entered in the remaining storage capacity may be decided, upon receiving a user-designated input, according to the designated input.

By so doing, it is possible to make adjustment that directly reflects the user's intention on the content of the stored words of the second dictionary for speech synthesis. Accordingly, the second dictionary for speech synthesis can be edited finely according to individual needs by individual users.

(8) In accordance with an embodiment of the invention, a semiconductor integrated circuit device includes a nonvolatile memory section that stores dictionary data composing the second dictionary for speech synthesis created by any of the systems for creating a dictionary for speech synthesis described above, and a synthesized speech data creation processing section that creates synthesized speech data corresponding to a predetermined utterance target sentence, using the dictionary data stored in the nonvolatile memory section.

(9) In accordance with an embodiment of the invention, a method for manufacturing a semiconductor integrated circuit device for speech synthesis including a nonvolatile memory section, the method including the steps of: analyzing an utterance target sentence that is scheduled to be speech-synthesized by the semiconductor integrated circuit device, checking frequency of occurrence of each word composing the utterance target sentence, deciding words to be stored in a second dictionary for speech synthesis based on the frequency of occurrence, and creating the second dictionary for speech synthesis for the decided stored words by using the first dictionary for speech synthesis; creating synthesized speech corresponding to the utterance target sentence using the second dictionary for speech synthesis; and writing dictionary data composing the created second dictionary for speech synthesis in the nonvolatile memory section of the semiconductor integrated circuit device.

### BRIEF DESCRIPTION OF THE DRAWINGS

FIG. 1 is a diagram for describing a speech synthesis dictionary creating system and a semiconductor integrated circuit device in accordance with an embodiment of the invention.

FIG. 2 shows an example of a functional block diagram of a speech synthesis dictionary creating system in accordance with the present embodiment.

FIG. 3 is a flow chart for describing a processing flow in accordance with the present embodiment.

FIG. 4 is a figure for describing an example of a change history recording processing at the time of replacement.

FIG. 5 is a figure for describing an example of a change history recording processing at the time of addition of Ruby characters (a kana replacement processing).

FIG. 6 is a diagram for describing a structure of a single chip TTS-LSI (semiconductor integrated circuit device) on which a subset dictionary is mounted.

FIG. 7 is a flow chart for describing a method for manufacturing a semiconductor integrated circuit device in accordance with an embodiment of the invention.

### DESCRIPTION OF EXEMPLARY EMBODIMENTS

Preferred embodiments of the invention are described below with reference to the accompanying drawings. It is noted that the embodiments described below would not unduly limit the contents of the invention described in the scope of the claimed invention. Also, all of the structures described below may not necessarily be indispensable components of the invention.

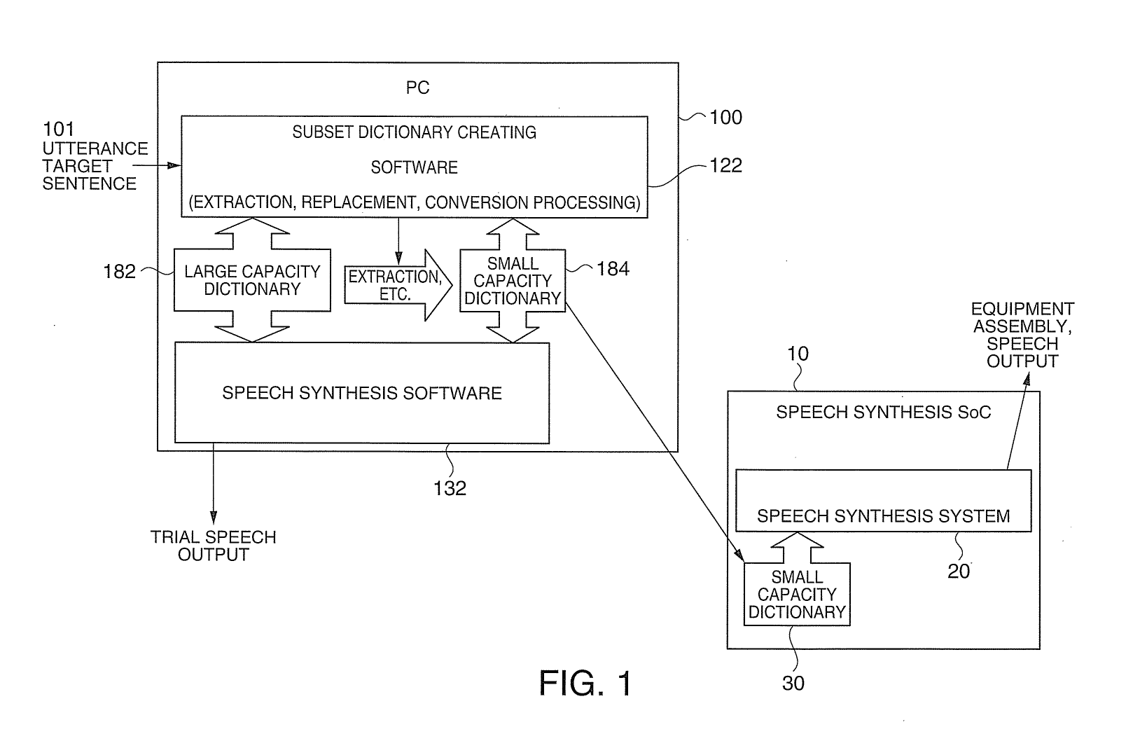

FIG. 1 is a diagram for describing a speech synthesis dictionary creating system in accordance with an embodiment of the invention and a semiconductor integrated circuit device having a dictionary for speech synthesis created by the speech synthesis dictionary creating system.

Reference numeral 100 denotes a speech synthesis dictionary creating system in accordance with the present embodiment. The speech synthesis dictionary creating system 100 has a large capacity dictionary (first dictionary for speech synthesis) 182 that is an aggregation of dictionary data necessary for creating synthesized speech corresponding to an utterance target sentence 101, and creates a small capacity dictionary (second dictionary for speech synthesis) 184 with a smaller data amount compared to the large capacity dictionary (first dictionary for speech synthesis) 182. The speech synthesis dictionary creating system 100 may be realized through installing a TTS compatible large capacity dictionary for speech synthesis, subset dictionary creating software for speech synthesis 122, and speech synthesis software 132 on a personal computer.

The large capacity dictionary for speech synthesis 182 functions as a first speech synthesis dictionary memory device that stores dictionary data composing the first dictionary for speech synthesis.

The subset dictionary creating software for speech synthesis 122 functions as a second speech synthesis dictionary creating device that analyzes the utterance target sentence, checks frequency of occurrence of each word composing the utterance target sentence, decides words to be stored in the small capacity dictionary (second dictionary for speech synthesis) 184 based on the frequency of occurrence, and creates the small capacity dictionary (second dictionary for speech synthesis) 184 for the decided stored words by using the dictionary data stored in the large capacity dictionary (first dictionary for speech synthesis) 182.

The subset dictionary creating software for speech synthesis 122 may function as an utterance target sentence changing device that performs a change of an utterance target sentence in which unstored words that are not subject to storing in the small capacity dictionary (second dictionary for speech synthesis) 184 among the words composing the utterance target sentence are replaced with stored words of the small capacity dictionary (second dictionary for speech synthesis) 184.

The subset dictionary creating software for speech synthesis 122 may function as an edit processing device that receives an evaluation input with respect to an utterance target sentence that is speech-synthesized by using the small capacity dictionary (the second dictionary for speech synthesis) 184, and renders a specifying or changing processing on the second dictionary for speech synthesis or the utterance target sentence according to the content of the evaluation input.

The speech synthesis software 132 functions as a speech synthesis device that creates synthesized speech corresponding to the utterance target sentence, using the small capacity dictionary (second dictionary for speech synthesis) 184. In effect, synthesized speech corresponding to the utterance target sentence can also be created by using the large capacity dictionary (first dictionary for speech synthesis) 182.

The speech synthesis dictionary creating system 100 in accordance with the present embodiment decides stored words based on the utterance target sentence, extracts dictionary data corresponding to the stored words from the large capacity dictionary (first dictionary for speech synthesis) 182, and stores the dictionary data in the small capacity dictionary (second dictionary for speech synthesis) 184.

The dictionary data in the small capacity dictionary is written in ROM (nonvolatile memory section) of TTS-LSI (an example of a semiconductor integrated circuit device) 10, thereby creating a smaller capacity dictionary.

TTS-LSI (an example of a semiconductor integrated circuit device) 10 has a small capacity dictionary 30 and a speech synthesis system 20 mounted thereon, and is a semiconductor integrated circuit device that creates synthesized speech data corresponding to a predetermined utterance target sentence. The small capacity dictionary 30 functions as a nonvolatile memory section that stores the dictionary data composing a dictionary for speech synthesis. The speech synthesis system 20 functions as a synthesized speech data creation processing section that creates synthesized speech data corresponding to the predetermined utterance target sentence, by using the dictionary data stored in the nonvolatile memory section.

In the present embodiment, a mountable speech dictionary file is limited to a relatively small amount of vocabulary, like in the case where vocabulary to be read out is application specified and has specific utility, or sentences to be read are already determined in advance like in the case of TTS-LSI (an example of an integrated circuit device) 10.

The small capacity dictionary (subset dictionary) 30 of TTS-LSI (an example of an integrated circuit device) 10 stores dictionary data composing the small capacity dictionary (second dictionary for speech synthesis) created through extracting dictionary data corresponding to vocabulary necessary for a predetermined utterance target sentence to be speech-synthesized by LLT-LSI (an example of an integrated circuit device) 10 from the large capacity dictionary (full-set dictionary) 182 on the personal computer 100.

By so doing, a dictionary for the specific use of LLT-LSI (an example of an integrated circuit device) 10 can be created, such that sufficient performance can be secured with a dictionary having a small storage capacity. Also, when utterance target sentences are already known, a dictionary limited to the vocabulary of the utterance target sentences is created, such that a waste of the resource can be eliminated, and the dictionary to be mounted on TTS-LSI (an example of an integrated circuit device) 10 can be optimized.

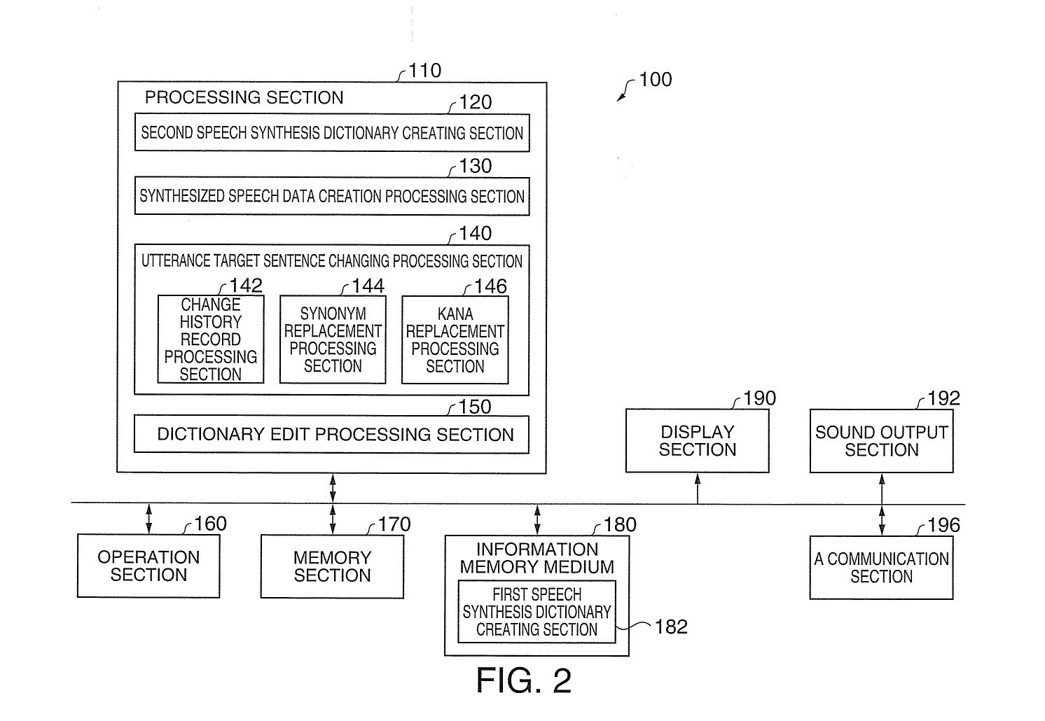

FIG. 2 shows an example of a functional block diagram of the speech synthesis dictionary creating system in accordance with the present embodiment. It is noted that the speech synthesis dictionary creating system 100 in accordance with the present embodiment may not need to include all of the components (each section) of FIG. 2, and may have a structure in which a part thereof is omitted.

An operation section 160 is provided for inputting operations by the user as inputs, and its function may be realized by hardware such as operation buttons, operation levers, touch panel, microphone and the like.

A memory section 170 defines a work area for a processing section 110 and a communication section 196, and its function may be realized by hardware such as RAM.

An information memory medium 180 (computer-readable medium) stores programs and data, and its function may be realized by hardware such as an optical disk (CD, DVD or the like), a magneto-optical disk (MO), a magnetic disk, a hard disk, a magnetic tape, a memory device (ROM), or the like.

Also, the information memory medium 180 stores programs that make the computer to function as each of the sections of the present embodiment and auxiliary data (additional data), and stores large capacity dictionary data for speech synthesis and functions as the first dictionary memory section for speech synthesis 182. Also, the information memory medium 180 may be arranged to store second dictionary data for speech synthesis that is extracted from the first dictionary for speech synthesis.

The processing section 110 performs a variety of processings in accordance with the present embodiment based on the programs (data) stored in the information memory medium 180 and data read from the information memory medium 180. In other words, the information memory medium 180 stores programs that render the computer to function as each of the sections of the present embodiment (programs to render the computer to execute each of the processings).

A display section 190 outputs an image created by the present embodiment, and its function may be realized by hardware such as a CRT display, an LCD (liquid crystal display), an OELD (organic EL display), a PDP (plasma display panel), or a touch-panel type display.

A sound output section 192 outputs synthesized speech created by the present embodiment and the like, and its function may be realized by hardware such as a loud speaker, a headphone or the like.

A communication section 196 performs various controls for communication with an external device (such as, for example, a host device and other terminal devices), and its function may be realized by hardware such as various processors or communication ASIC, or programs.

It is noted that the programs (data) that render the computer to function as each of the sections of the present embodiment may be distributed to the information memory medium 180 (or the memory section 170) through networks and the communication section 196 from information memory media of a host apparatus (server apparatus). The use of the host apparatus (server apparatus and the like) and the information memory media can be included in the scope of the invention.

The processing section 110 (processor) performs various processings based on operation data given from the operation section 160 and programs, using the memory section 170 as a work area. The functions of the processing section 110 may be realized by hardware such as various processors (CPU, DSP and the like), ASIC (gate arrays and the like), or programs.

The processing section 110 includes a second speech synthesis dictionary creating section 120, a synthesized speech data creation processing section 130, an utterance target sentence changing processing section 140, and a dictionary edit processing section 150.

The second speech synthesis dictionary creating section 120 analyzes an utterance target sentence, checks frequency of occurrence of each word composing the utterance target sentence, decides words to be stored in the second dictionary for speech synthesis based on the frequency of occurrence, and creates the second dictionary for speech synthesis using the dictionary data stored in the first dictionary for speech synthesis corresponding to the decided words to be stored.

The synthesized speech data creation processing section 130 creates synthesized speech data corresponding to the utterance target sentence, using the second dictionary for speech synthesis.

The utterance target sentence changing processing section 140 performs a change of an utterance target sentence in which unstored words that are not subject to storing in the second dictionary for speech synthesis among words composing an utterance target sentence are changed with the stored words in the second dictionary for speech synthesis.

The utterance target sentence changing processing section 140 includes a change history record processing section 142, a synonym replacement processing section 144, and a kana replacement processing section 146.

The change history record processing section 142 performs processing to record a change history concerning replacement of words composing the utterance target sentence.

The synonym replacement processing section 144 performs a synonym replacement processing in which the unstored words are analyzed to check whether their synonyms are present in the stored words in the second dictionary for speech synthesis, and when there are synonyms, the unstored words of the utterance target sentence are replaced with the synonyms.

The kana replacement processing section 146 performs a kana replacement processing in which the unstored word is replaced with its equivalent kana notation that represents how the word is read.

The dictionary edit processing section 150 receives an evaluation input with respect to an utterance target sentence that is speech-synthesized by using the second dictionary for speech synthesis, and performs a specifying or changing processing on the second dictionary for speech synthesis or the utterance target sentence according to the content of the evaluation input.

Also, the dictionary edit processing section 150 may receive a user-designated input about stored words of the second dictionary for speech synthesis, and the second speech synthesis dictionary creating device 120 may decide a stored word based on the user-designated input.

Next, operations of the present embodiment are described with reference to a concrete example.

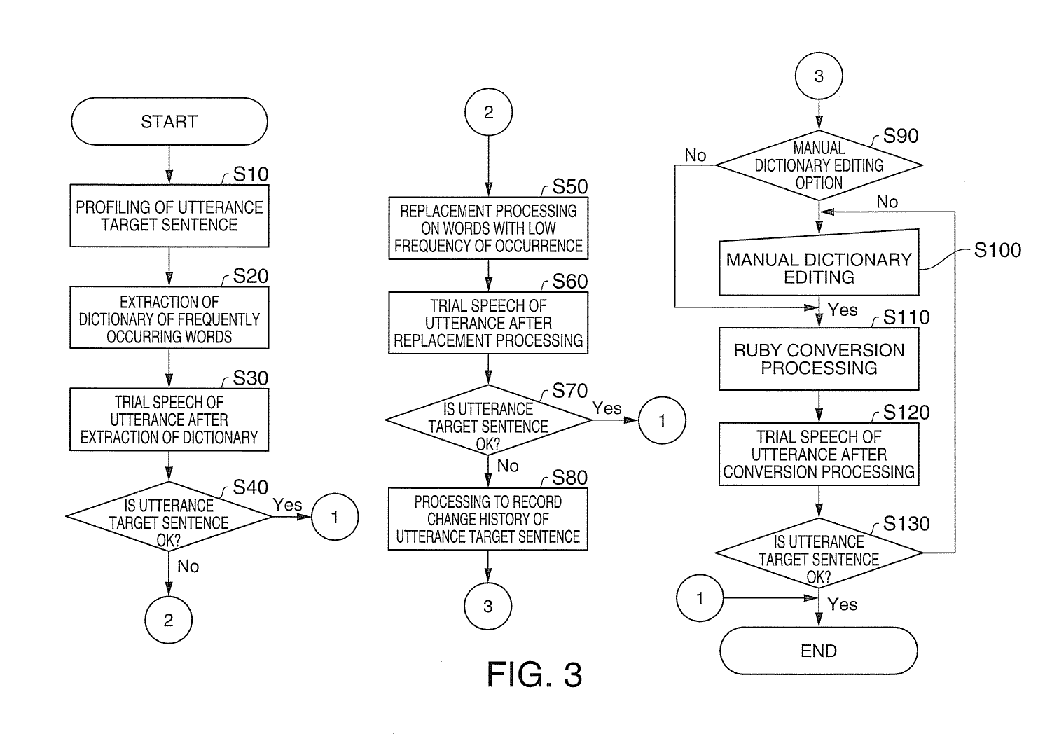

FIG. 3 is a flow chart for describing a processing flow in accordance with the present embodiment.

First, a profiling of an utterance target sentence is performed (step S10). For example, the utterance target sentence is divided into vocabularies, and frequency of occurrence of each of the vocabularies is counted.

Next, a dictionary of frequently occurring words is extracted (first extraction) (step S20). For example, of the storage capacity allocated in advance to a dictionary, a specific ratio (for example, 80%) may be allocated to vocabularies according to priority of higher frequency of occurrence, based on the profiling data described above. In this instance, if the frequency of occurrence does not reach a specified number (for example, twice), the allocation may be stopped even when the aforementioned ratio is not reached. The frequency of appearance generally forms a “long tail” type distribution, and therefore it can be expected that many parts of the target sentence can be covered at this stage by the subset dictionary.

Next, trial speech of the utterance target sentence is conducted using the subset dictionary after the first extraction (step S30).

Upon receiving a confirmation input (for example, OK or NG) by the user, the processing is finished if OK (the content of the subset dictionary is specified with the content after the first extraction), and the succeeding processing is conducted if NG (step S40).

Next, a processing to replace vocabularies of low frequency of occurrence is conducted (step S40). Vocabularies that are not caught in the first extraction process are checked as to whether they can be replaced by using a “synonym” dictionary. An examination is conducted to check if replacement of a vocabulary with an already allocated vocabulary is possible, and if plural vocabularies can be grouped to a single vocabulary by replacement is possible, and the utterance target sentence is changed by replacement (step S50).

Next, trial speech of the utterance target sentence after the change is conducted, using the subset dictionary after the first extraction, which is noted for confirmation by the user (step S60). The confirmation may be made, for example, in the form of outputting the changed portion in texts or the like and displaying the same on a screen. Even in this case, the speech after the change may preferably be confirmed as this method can avoid an error.

Acceptance or rejection of the resultant replacement may be once presented to the user, and then can be added to the dictionary upon user's decision, or those of the vocabularies that can be replaced may be in any event preferentially replaced. In this instance, vocabularies that have already been allocated do not need to be added to the dictionary, the vocabularies in the utterance target sentence are to be replaced. Also, when sorting the vocabularies according to priority of frequency of occurrence, and vocabularies with higher frequency of occurrence are added to the subset dictionary within the range of the remaining portion of the already allocated ratio, a search may be made as to whether there are replaceable vocabularies for the additional vocabularies, and newly added vocabularies may be replaced in the utterance target sentence.

Upon receiving a confirmation input (for example, OK or NG) by the user, the processing is finished if OK (the content of the subset dictionary is specified with the content after the first extraction), and the succeeding processing is conducted if NG (step S70).

Next, a processing to record the changes of the utterance target sentence as a change history is conducted (step S80).

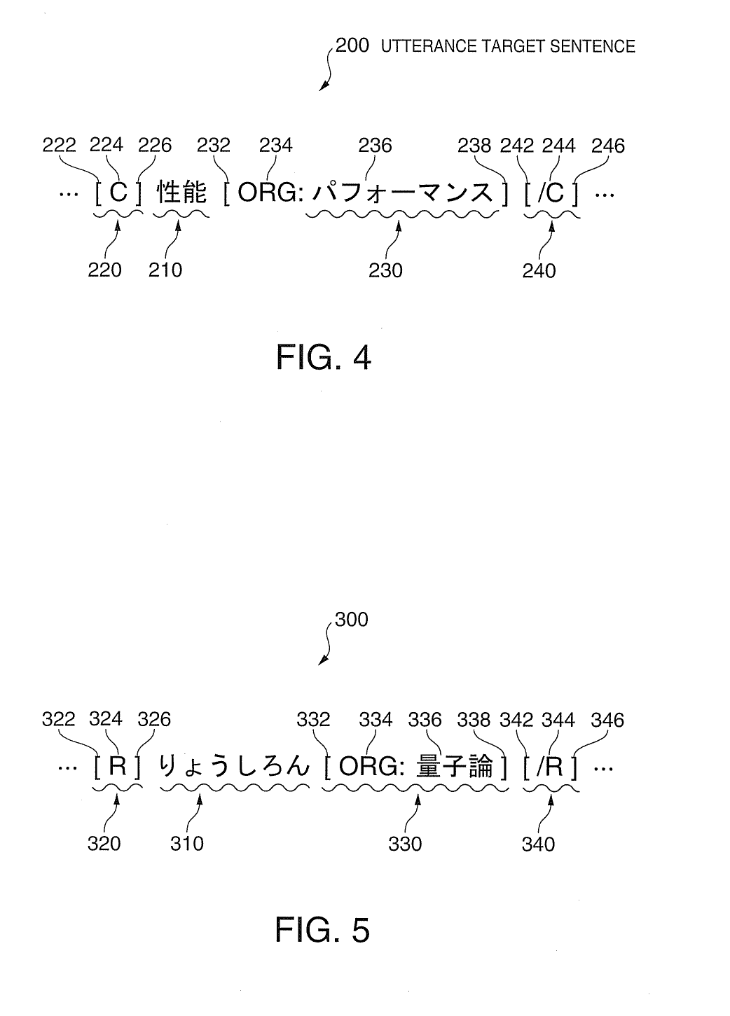

FIG. 4 is a figure for describing an example of a change history recording processing at the time of replacement.

For example, as shown in FIG. 4, comments 220, 230 and 240 may be inserted in an utterance target sentence 200 to leave the change history of the utterance target sentence. The comments may be enclosed by brackets or the like (222 and 226, 232 and 238 and 232 and 236 in FIG. 4) to show that they are comments such that the comments can be distinguished from the utterance target sentence.

Reference numeral 210 in this example is a replacement word (a part of the utterance target sentence). The comments 220 and 240 are placed before and after the replacement word, and indicate that the portion interposed between these comments is the replacement word. Reference numeral 230 is a comment that indicates that the original word (the word included in the original utterance target sentence) corresponding to the replacement word is [symbol] .

Next, the user is asked to confirm if manual editing needs to be conducted and a manual dictionary edit processing is conducted if such manual editing is needed (steps S90 and S100). Vocabularies in the utterance target sentence that are not extracted may be sorted according to priority of frequency of occurrence, and vocabularies with higher frequency of occurrence may be added to the subset dictionary within the range of the remaining portion of the already allocated ratio.

For a word that cannot be coped with by the processing described above, its registration as a word is abandoned, and Ruby characters (kana characters) may be inserted in the utterance target sentence such that the word is changed into “utterance by monosyllables” (step S110).

FIG. 5 is a figure for describing an example of a change history recording processing at the time of addition of Ruby characters (a kana replacement processing).

For example, when a vocabulary [symbol] cannot be registered, the vocabulary is changed to Ruby characters [symbol] (kana characters like katakana or hiragana characters), as indicated by reference numeral 310 in FIG. 5. In this instance, text tagging may be made in a manner shown in FIG. 5 to indicate the corresponding portion is indicated by Ruby characters, and the original vocabulary is [symbol] though it is not pronounced.

More specifically, comments 320, 330 and 340 are inserted in an utterance target sentence 300 as indicated in FIG. 5. Reference numeral 310 denotes the kana characters (a portion of the utterance target sentence) after the kana conversion. The comments 320 and 340 are placed before and after the kana converted word, and indicate that the portion interposed between these comments is the kana converted word. The comment 330 indicates that the original vocabulary (a vocabulary included in the original utterance target sentence) corresponding to the kana converted word is

[symbol]

The subset dictionary (second dictionary for speech synthesis) includes speech synthesis data for kana notations, such that words expressed by kana characters can be pronounced. However, they can only be recognized as kana characters, and therefore it is difficult to create intonation and accent characteristic to the words, and they may be pronounced generally in a manner without intonation or accent.

Then, trial speech of the utterance target sentence after the change is conducted using the subset dictionary, and the user is notified for confirmation (step S120).

Upon receiving a confirmation input (for example, OK or NG) by the user, the processing is finished if OK (the content of the subset dictionary is specified with the content after the first extraction), and the process returns to step S100, and the succeeding processing is conducted if NG (step S130).

In the embodiment described above, extraction of a vocabulary dictionary for a subset dictionary is described as an example. According to the method, by narrowing down the vocabularies, phonemes can also be narrowed down to those corresponding only to the extracted vocabularies. As a result, the subset phoneme dictionary can also be made smaller.

However, when the subset phoneme dictionary has a problem in its size, works such as retrials may be conducted while changing the ratio in the first extraction.

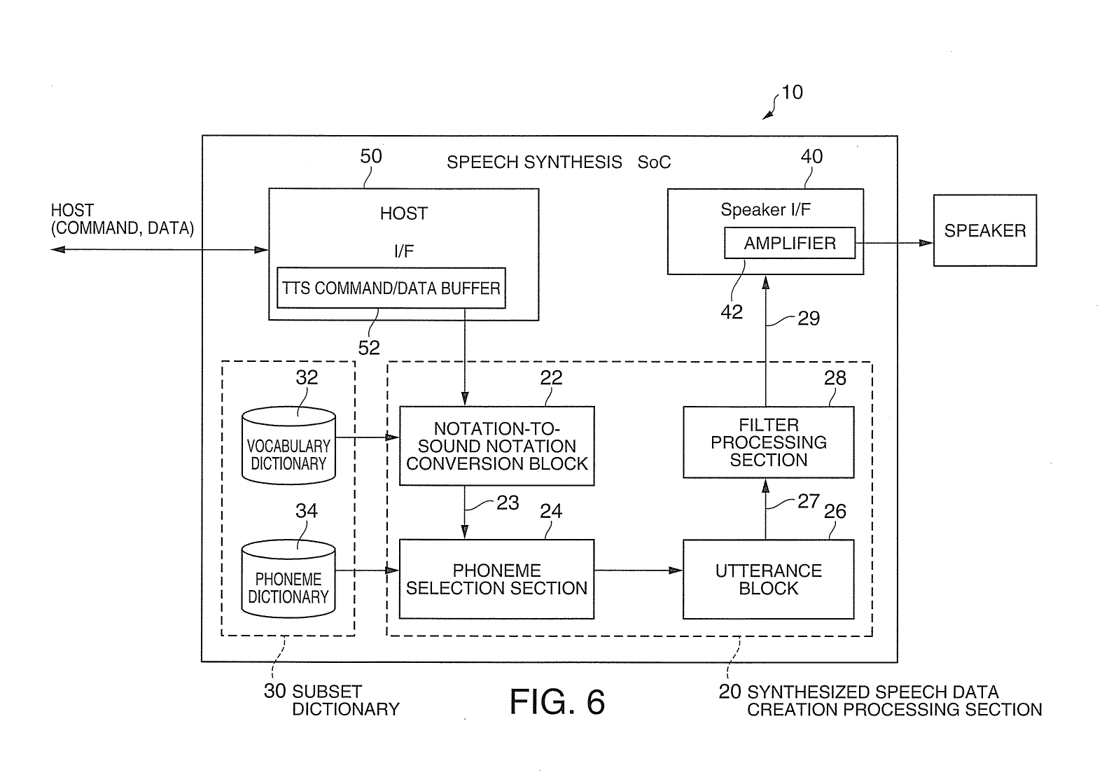

FIG. 6 is a diagram for describing a structure of a single chip TTS-LSI (semiconductor integrated circuit device) on which a subset dictionary is mounted.

The single chip TTS-LSI 110 includes a subset dictionary 30. The subset dictionary 30 functions as a nonvolatile memory section that stores dictionary data composing the second dictionary for speech synthesis created by the speech synthesis dictionary creating system in accordance with the present embodiment. The subset dictionary 30 includes a vocabulary dictionary 32 and a phoneme dictionary 34, and may be realized by ROM, flash EEPROM or the like.

The vocabulary dictionary 32 is a dictionary for performing a front-end processing in the text read-out processing, and is a dictionary that stores symbolic linguistic representations corresponding to text notations (for example, read-out data corresponding to text notations).

In the front-end processing, a processing to convert symbols like numbers and abbreviations contained in text into the equivalent of read-out words (which is called text normalization, pre-processing, or tokenization), and a processing to convert each word into phonetic transcriptions to thereby divide text into prosodic units, such as, phrases, clauses and sentences (the process to assign phonetic transcriptions to each word is called text-to-phoneme (TTP) conversion or grapheme-to-phoneme (GTP) conversion) are conducted. Phonetic transcriptions and prosodic information are combined together to make up the symbolic linguistic representation that is outputted by the front-end.

The phoneme dictionary 34 is a dictionary that stores waveform information of actual sounds (phoneme) corresponding to inputted symbolic linguistic representation that is output of the front-end.

The subset dictionary 30 stores data of the second dictionary for speech synthesis that is created by the speech synthesis dictionary creating system. For example, the subset dictionary 30 may be formed from the vocabulary dictionary created by the process described with reference to FIG. 3 and a phoneme dictionary composed of phoneme dictionary data necessary for the vocabulary dictionary.

The single chip TTS-LSI 110 includes a host I/F 50. The host I/F 50 is an interface block for interchanging commands and data with the host computer. The host I/F 50 includes a TTS command/data buffer 52 that stores an utterance target sentence (text data) designated by the host. The utterance target sentence is inputted to a synthesized speech data creation processing section 20.

The single chip TTS-LSI 110 includes the synthesized speech data creation processing section 20. The synthesized speech data creation processing section 20 functions as a synthesized speech creation section that creates synthesized speech data corresponding to a specified utterance target sentence, using the dictionary data (subset dictionary) stored in the nonvolatile memory section 30. The synthesized speech data creation processing section 20 includes a notation-to-sound notation conversion block 22, a phoneme selection section 24, an utterance block 26, and a filter processing section 28. The function of each of the sections may be realized by a dedicated circuit, or may be realized by CPU executing a program for realizing the function of each of the sections. The functions of the synthesized speech data creation processing section 20 are equivalent to the functions of the synthesized speech data creation processing section 130 of the speech synthesis dictionary creating system shown in FIG. 2.

The notation-to-sound notation conversion block 22 searches in the vocabulary dictionary 32 to thereby convert an utterance target sentence into symbolic linguistic representation that is transferred to the phoneme selection section 24.

The phoneme selection section 24 receives the symbolic linguistic representation 23 of the utterance target sentence, searches in the phoneme dictionary 34 and gives an aggregation of phonemes corresponding to the symbolic linguistic representation 23 to the utterance block 26.

The utterance block 26 creates synthesized speech waveform 27 based on the aggregation of phonemes.

The filter processing section 28 changes the sound quality of the synthesized speech waveform or changes the character of the utterance into a different character.

The single chip TTS-LSI 110 includes a speaker I/F 40. The synthesized speech waveform filtered by the filter processing section 28 is outputted to an external speaker through an amplifier 42 of the speaker I/F 40.

The single-chip TTS-LSI 10 in accordance with the present embodiment has only a small capacity subset dictionary, and is capable of creating accurate synthesized speech data for predetermined utterance target sentences corresponding to equipment in which the single-chip TTS-LSI 10 is assembled.

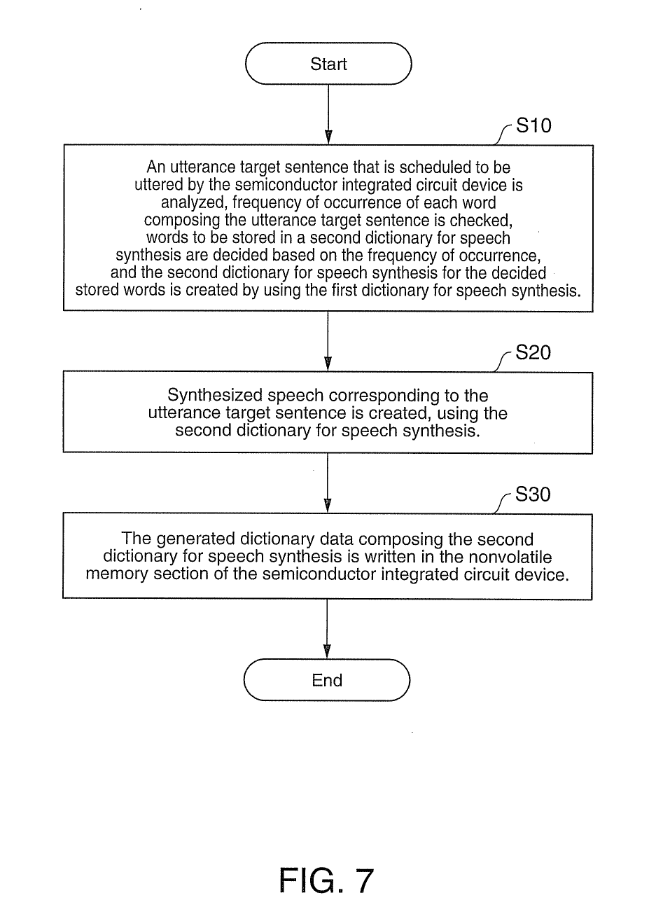

FIG. 7 is a flow chart for describing a method for manufacturing a semiconductor integrated circuit device in accordance with an embodiment of the invention. The semiconductor integrated circuit device in accordance with the present embodiment is a semiconductor integrated circuit device including a synthesized speech data creating processing section and a nonvolatile memory section that stores dictionary data used for speech synthesis processing, and is manufactured through the following steps.

First, an utterance target sentence that is scheduled to be uttered by the semiconductor integrated circuit device is analyzed, frequency of occurrence of each word composing the utterance target sentence is checked, words to be stored in a second dictionary for speech synthesis are decided based on the frequency of occurrence, and the second dictionary for speech synthesis for the decided stored words is created by using the first dictionary for speech synthesis (step S10).

Synthesized speech corresponding to the utterance target sentence is created, using the second dictionary for speech synthesis (step S20). Upon receiving an evaluation input from the user with respect to the synthesized speech, the content of the second dictionary for speech synthesis may be specified when the user's evaluation is OK, and editing of the second dictionary for speech synthesis may be continued when the user's evaluation is NG.

Then, the generated dictionary data composing the second dictionary for speech synthesis is written in the nonvolatile memory section of the semiconductor integrated circuit device (step S30). For example, the dictionary data composing the second dictionary for speech synthesis may be written in the nonvolatile memory section as a mask ROM at the time of manufacturing the semiconductor integrated circuit device.

It is noted that the invention is not limited to the embodiments described above, and a variety of modifications can be implemented within the scope of the subject matter of the invention.

Also, the invention is applicable to TTS systems for languages other than the Japanese language.

What is claimed is:

1. A system for creating a dictionary for speech synthesis, the system having a first dictionary for speech synthesis composed of an aggregation of dictionary data necessary for creating synthesized speech corresponding to an utterance target sentence, wherein the system creates, from the first dictionary for speech synthesis, a second dictionary for speech synthesis with a fewer data amount compared to the first dictionary for speech synthesis, the system comprising:
a first speech synthesis dictionary memory device that stores the dictionary data composing the first dictionary for speech synthesis;
a second speech synthesis dictionary creating device that analyzes an utterance target sentence, checks frequency of occurrence of each word composing the utterance target sentence, decides words to be stored in the second dictionary for speech synthesis based on the frequency of occurrence, and creates the second dictionary for speech synthesis using the dictionary data stored in the first dictionary for speech synthesis corresponding to the decided words to be stored; and
a speech synthesis device that creates synthesized speech corresponding to the utterance target sentence, using the second dictionary for speech synthesis.

2. A system for creating a dictionary for speech synthesis according to claim 1, further comprising an utterance target sentence changing device that changes an utterance target sentence in which unstored words that are not subject to storing in the second dictionary for speech synthesis among words composing an utterance target sentence are changed with the stored words in the second dictionary for speech synthesis.

3. A system for creating a dictionary for speech synthesis according to claim 2, wherein the utterance target sentence changing device creates a dictionary for speech synthesis characterizing in recording a change history concerning replacement of words composing the utterance target sentence.

4. A system for creating a dictionary for speech synthesis according to claim 2, wherein the utterance target sentence changing device includes a synonym replacement processing device that performs a synonym replacement processing in which the unstored words are analyzed to check whether corresponding synonyms are present in the stored words in the second dictionary for speech synthesis, and when there are synonyms, the unstored words in the utterance target sentence are replaced with the synonyms.

5. A system for creating a dictionary for speech synthesis according to claim 2, wherein the utterance target sentence changing device includes a kana replacement processing device that performs a kana replacement processing in which the unstored word is replaced with corresponding kana notation that represents how the word is read.

6. A system for creating a dictionary for speech synthesis according to claim 1, comprising an edit processing device that receives an evaluation input with respect to an utterance target sentence that is speech-synthesized by using the second dictionary for speech synthesis, and performs a specifying or changing processing on the second dictionary for speech synthesis or the utterance target sentence according to the content of the evaluation input.

7. A system for creating a dictionary for speech synthesis according to claim 1, wherein the edit processing device receives a user-designated input about a stored word of the second dictionary for speech synthesis, and the second speech synthesis dictionary creating device decides the stored word based on the user-designated input.

8. A semiconductor integrated circuit device comprising:
a nonvolatile memory section that stores dictionary data composing a second dictionary for speech synthesis created by the system for creating a dictionary for speech synthesis recited in claim 1; and
a synthesized speech data creation processing section that creates synthesized speech data corresponding to a predetermined utterance target sentence, using the dictionary data stored in the nonvolatile memory section.

9. A method for manufacturing a semiconductor integrated circuit device for speech synthesis including a nonvolatile memory section, the method comprising the steps of:
analyzing an utterance target sentence that is scheduled to be speech-synthesized by the semiconductor integrated circuit device, checking frequency of occurrence of each word composing the utterance target sentence, deciding words to be stored in a second dictionary for speech synthesis based on the frequency of occurrence, and creating the second dictionary for speech synthesis for the decided stored words by using the first dictionary for speech synthesis;
creating synthesized speech corresponding to the utterance target sentence using the second dictionary for speech synthesis; and
writing dictionary data composing the created second dictionary for speech synthesis in the nonvolatile memory section of the semiconductor integrated circuit device.

10. A system that creates a dictionary for text-to-speech reading machine, the system comprising:
a first speech synthesis dictionary memory device that stores a first dictionary for speech synthesis;
a second speech synthesis dictionary creating device that analyzes a sentence, checks frequency of occurrence of each word composing the sentence, decides words to be stored in a second dictionary for speech synthesis based on the frequency of occurrence, and creates the second dictionary for speech synthesis using the dictionary data stored in the first dictionary for speech synthesis corresponding to the decided words to be stored; and
a speech synthesis device that creates synthesized speech corresponding to the sentence, using the second dictionary for speech synthesis,
the second speech synthesis dictionary creating device has fewer data amount compared to the first dictionary for speech synthesis.
